(19) United States
(12) Patent Application Publication
(10) Pub. No.: US 2008/0123910 A1
(43) Pub. Date: May 29, 2008

(54) METHOD AND SYSTEM FOR PROVIDING ACCURACY EVALUATION OF IMAGE GUIDED SURGERY

(75) Inventor: Chuanggui Zhu, Singapore (SG)

Correspondence Address: VOLUME INTERACTIONS PTE LTD, INTELLECTUAL PROPERTY DEPT., 7905 FULLER ROAD, EDEN PRAIRIE, MN, 55344, US

(73) Assignee: BRACCO IMAGING SPA, Milano (IT)

(21) Appl. No.: 11/533,350

(22) Filed: Sep. 19, 2006

(51) Int. Cl. G06K 9/00

(52) U.S. Cl. 382/128

(57) ABSTRACT

Methods and systems for the accuracy evaluation of an Image Guided Surgery system. One embodiment includes: identifying a position of a landmark in a three-dimensional image of an object; and overlaying a first marker on a reality view of the object according to registration data that correlates the three-dimensional image of the object with the object, to represent the position of the landmark as being identified in the three-dimensional image. In one embodiment, the reality view of the object includes a real time image of the object; a position of the landmark is determined on the object via a position determination system; and a second marker is further overlaid on the real time image of the object, to represent the position of the landmark as being determined via the position determination system.

### FIELD

The disclosure includes technologies which generally relate to image guided surgery (IGS).

### BACKGROUND

A major difficulty facing a surgeon during a traditional surgical procedure is that the surgeon cannot see beyond the exposed surfaces and surgical opening of a patient. Accordingly, the surgeon's field of vision may not include the internal anatomical structures that surround the surgical opening or are present along the surgical path. The surgeon traditionally had to create a larger surgical opening to see these internal anatomical structures. Even with a larger opening, the surgeon had a limited ability to see the internal anatomical structures that were located behind other anatomical structures. Consequently, patients underwent painful surgeries that had limited planning and potentially led to large scarring.

In order to help the surgeon better visualize these internal anatomical structures, various imaging techniques have been developed. For instance, Magnetic Resonance Imaging (“MRI”), Computed Tomography (“CT”), and Three-Dimensional Ulstrasonography (“3DUS”) are all imaging techniques that the surgeon can utilize to scan a patient and obtain scan data that illustrates the internal anatomical structures of the patient prior to surgery. For instance, a computer can be utilized to process the scan data and generate a computerized three-dimensional image of internal and external anatomical structures of the patient.

These images can be used during an actual surgical procedure. Real time information, such as the position of a surgical probe with respect to the internal anatomical structures of the patient, can be provided to guide the surgery and help ensure precise incisions and avoid damage to other internal anatomical structures. As a result, the surgeon is better able to visualize the anatomical structures of the patient and does not need to make as large of a surgical opening. With more thorough pre-operative planning and intra-operative image-based guidance, the surgeon can perform a minimally invasive surgery (“MIS”) that leads to less pain and scarring for the patient.

For instance, U.S. Pat. No. 5,383,454 discloses a system for indicating the position of a tip of a probe within an object on cross-sectional, scanned images of the object. U.S. Pat. No. 6,167,296 describes a system for tracking the position of a pointer in real time by a position tracking system to dynamically display 3-dimensional perspective images in real time from the viewpoint of the pointer based on scanned image data of a patient. Such surgical navigation systems can, for example, display the localization of a currently held tool in relation to surrounding structures within a patient's body. The surrounding structures can be part of, or generated from, the scan image. The surrounding structures are aligned with a patient's corresponding real structures through the registration process. Thus, what is shown on the monitor is the analogous point of the held probe in relationship to the patient's anatomic structure in the scan data.

In applications of such surgical navigation systems, the analogous position of surgical instruments in relative to the patient's anatomic structure displayed on the monitor should represent precisely the position of the real surgical instruments in relative to the real patient. However, various sources of error, including registration error, tracking error, calibration error, and geometric error in the scan data, can introduce inaccuracies in the displayed position of surgical instruments in relative to the anatomic structures of the patient. As a result, the position of surgical instruments in relative to certain areas or anatomic structures displayed may be located at a place slightly different from the real position of surgical instruments in relative to the corresponding areas or anatomic structures in the patient.

International Patent Application Publication No. WO 02/100284 A1 discloses an Augmented Reality (AR) surgical navigation system in which a virtual image and a real image are overlaid together to provide the visualization of augmented reality. International Patent Application Publication No. WO 2005/000139 A1 discloses an AR aided surgical navigation imaging system in which a micro-camera is provided in a hand-held navigation probe so that a real time image of an operative scene can be overlaid with a computerized image generated from pre-operative scan data. This enables navigation within a given operative field by viewing real-time images acquired by the micro-camera that are combined with computer generated 3D virtual objects from prior scan data depicting structures of interest.

In such AR aided surgical navigation systems, the superimposed images of virtual structures (e.g., those generated from a patent's pre-operative volumetric data) should coincide precisely with their real equivalents in the real-time combined image. However, various sources of error can introduce inaccuracies in the displayed position of certain areas of the superimposed image relative to the real image. As a result, when a 3D rendering of a patient's volumetric data is overlaid on a real-time camera image of that patient, certain areas or structures appearing in the 3D rendering may be located at a place slightly different from the corresponding area or structure in the real-time image of the patient. Thus, a surgical instrument that is being guided with reference to locations in the 3D rendering may not be directed exactly to the desired corresponding location in the real surgical field.

### SUMMARY

Methods and systems for the accuracy evaluation of an Image Guided Surgery System are described herein. Some embodiments are summarized in this section.

One embodiment includes: identifying a position of a landmark in a three-dimensional image of an object; and overlaying a first marker on a reality view of the object according to registration data that correlates the three-dimensional image of the object with the object, to represent the position of the landmark as being identified in the three-dimensional image. In one embodiment, the reality view of the object includes a real time image of the object; a position of the landmark is determined on the object via a position determination system; and a second marker is further overlaid on the real time image of the object, to represent the position of the landmark as being determined via the position determination system

The disclosure includes methods and apparatus which perform these methods, including data processing systems which perform these methods and computer readable media which when executed on data processing systems cause the systems to perform these methods.

Other features will be apparent from the accompanying drawings and from the detailed description which follows.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 illustrates an Image Guided Surgery (IGS) system;

FIG. 2 illustrates a display device showing a Triplanar view;

FIG. 3 illustrates the visualization of scan data of an anatomical structure of the patient;

FIG. 4 illustrates the markers that are displayed at the selected locations of the landmarks to indicate the positions of the landmarks in the scan data;

FIG. 5 illustrates the display device showing an Augmented Reality view and a Triplanar view;

FIG. 6 illustrates the display device showing a plurality of pairs of markers;

FIG. 7 illustrates the spatial relation of registration error;

FIG. 8 illustrates a process for performing accuracy evaluation for an Image Guided Surgery (IGS) system;

FIGS. 9A and 9B illustrate the display device showing both Augmented Reality and Triplanar views;

FIG. 10 illustrates a process for the visualization of registration accuracy; and

FIG. 11 illustrates a block diagram of a system that can be utilized to perform accuracy evaluation of an Image Guided Surgery (IGS) system.

### DETAILED DESCRIPTION

Methods and systems are disclosed for the determination of the accuracy of an Image Guided Surgery (IGS) system. The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure can be, but not necessarily are, references to the same embodiment; and, such references mean at least one.

In one embodiment, the accuracy of the IGS system can be determined and/or visualized (e.g., prior to actually performing the surgery).

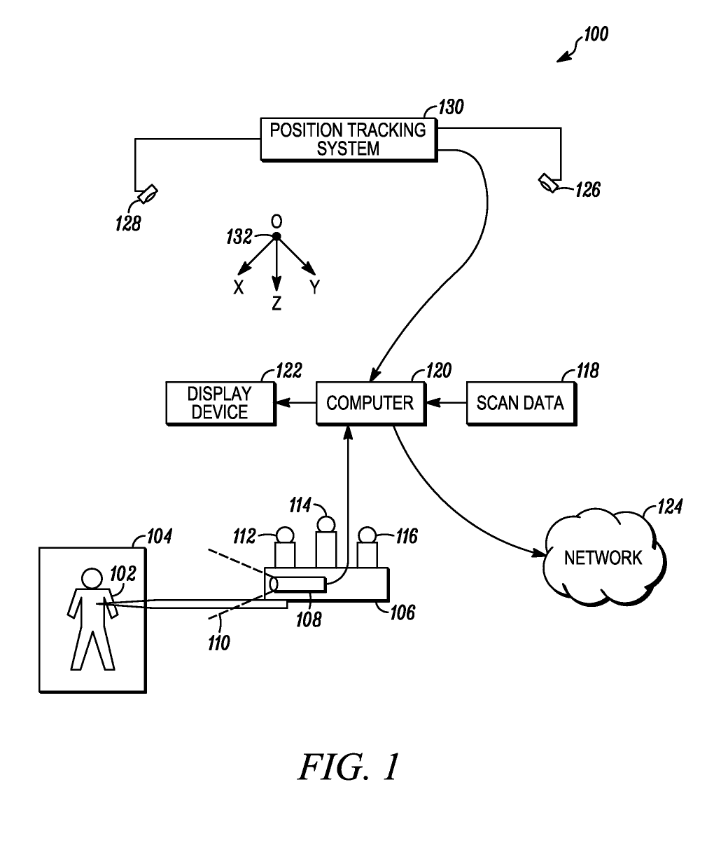

FIG. 1 illustrates an Image Guided Surgery (IGS) system 100. A surgeon can utilize the IGS system 100 to perform a surgical procedure on a patient 102 that is positioned on an operating table 104. The surgeon can utilize a probe 106 in performing the surgical procedure, e.g., to navigate through the anatomical structures of the patient 102. To help the surgeon visualize the external and internal anatomical structures, a display device 122 is provided that can display computerized images modeled from pre-operative data (e.g., scan data 118), real time images (e.g., a video image from video camera 108), and/or the position information provided by a position tracking system 130.

In one embodiment, with respect to generating the computerized images, scan data 118 is obtained from the patient 102 prior to surgery. The scan data 118 can include data determined according to any of the imaging techniques known to one of ordinary skill in the art, e.g., MRI, CT, and 3DUS. Prior to surgery, the scan data 118 can be utilized in surgical planning to perform a diagnosis, plan a surgical path, isolate an anatomical structure, etc. During the surgery, the scan data 11 8 can be provided to a computer 120, which can generate a computerized image of an anatomical structure, or a plurality of anatomical structures, of the patient 102, the diagnosis information, and/or the surgical path. The computerized image can be two-dimensional or three-dimensional. An anatomical structure of the patient 102 can be rendered partially transparent to allow the surgeon to see other anatomical structures that are situated behind the anatomical structure. The computerized image can be shown on the display device 122. In addition, the computer 120 can be connected to a network 124 to transmit and receive data (e.g., for the display of the computerized image and/or the augmented reality at a remote location outside of the operating room).

In one embodiment, to utilize the computerized image to guide the surgical operation, the probe 106 is identified within the computerized image on the display device 122. For example, a representation of the probe 106 or the tip of the probe 106 can be provided in the computerized image. For example, an icon, or a computer model of the probe 106, can be displayed within the computerized image to indicate where the tip of the probe 106 is with respect to the anatomical structure in the computerized image, based on the location of the probe as determined by the position tracking system 130.

The position of the probe 106 is typically measured according to a coordinate system 132, while the scan data 118 and/or information derived from the scan data 118 is typically measured in a separate coordinate system. A registration process is typically performed to produce registration data that can be utilized to map the coordinates of the probe 106 (and/or the positions of specific markers as determined by the position tracking system 130) and scan data 118 of the patient 102 into a common system (e.g., in a coordinate system used by the display device 122, or in the coordinate system 132 of the tracking system, or in the coordinate system of the scan data). After the registration, the scan data 118 can be mapped to the real space in the operating room so that the image of the patient in the scan data is aligned with the patient; and the scanned image of the patient can virtually represent the patient.

In one embodiment, to obtain the registration data, a registration process is performed to correlate multiple points on the patient 102 as determined by the position tracking system 130 and corresponding points in the scan data 118. For example, three corresponding points on a patient can be identified in the position tracking coordinate space 132 using the probe 106. Through correlating the three points with the corresponding points in the scan data, a transformation can be calculated so that there is a mapping from the position tracking coordinate system 132 to the coordinate system of the scan data 118. This mapping can be utilized as the registration data to align other points on the patient 102 with corresponding points in the scan data 118. In one embodiment, more than three points can be utilized in the registration process. A transformation is determined to best correlate the points determined by the position tracking system 130 and the corresponding points in the scan data 118.

For example, fiducial markers can be placed on the patient 102 prior to a scan. The markers appearing in the scan data 118 can be identified in the coordinate system of the scan data. Further, the positions of the fiducial markers on the patient 102 can be determined using the position tracking system 130 during the registration process. Matching up the coordinates of the markers on the patient 102 with those of the markers appearing in the scan data leads to the transformation between the position tracking coordinate system 132 and the coordinate system of the scan data 118.

For example, the probe 106 can be utilized to determine the position of the fiducial markers in the position tracking coordinate system 132. For instance, the probe 106 includes a set of reflective balls, e.g., a first reflective ball 112, a second reflective ball 114, and a third reflective ball 116. The positions of the reflective balls in the position tracking coordinate system 132 can be determined automatically by the position tracking system 130 via the tracking cameras, e.g., the first tracking camera 126 and the second tracking camera 128. Based on the positions of the set of reflective balls and the known geometric relation between the reflective balls and the probe 106, the position tracking system 130 can determine the position and orientation of the probe 106 and the position of the tip of the probe 106 in the position tracking coordinate system 132. When the tip of the probe 106 touches a fiducial marker, the position of fiducial marker can be determined from the position of the tip of the probe 106.

Alternatively, a surface registration process can be utilized. Surface based registration does not require the utilization of fiducials. For example, a surface model of an anatomical structure (e.g., the skin of the head) can be generated from the scan data 118. The probe 106 can be moved on the corresponding surface of the patient 102 (e.g., the head) to collect a plurality of points, each having 3-D coordinates in the position tracking system coordinate system 132 as determined by the position tracking system 130. Best fitting the plurality of points to the surface model of the anatomical structure can generate a transformation for the registration of the scan data to the patient.

Further details for performing a registration can be found in U.S. patent application Ser. No. 10/480,715, filed Jul. 21, 2004 and entitled “Guide System and a Probe Therefor”, which is hereby incorporated herein by reference in its entirety.

In one embodiment, real time images of the anatomical structure of the patient 102 are obtained from a video camera 108 that is mounted on or in the probe 106. The video camera 108 has a viewing angle 110 that covers at least a tip portion of the probe 106. In one embodiment, the video camera 108 has a pre-determined position and orientation with respect to the probe 106. Accordingly, the position and orientation of the video camera 108 can be determined from the position and orientation of the probe 106. The position tracking system 130 is utilized to determine the position of the probe 106. For instance, the position tracking system 130 can utilize the first tracking camera 126 and the second tracking camera 128 to capture the scene in which the probe 106 is positioned. The position tracking system 130 can determine the position of the probe 106 by identifying tracking indicia on the probe 106, e.g., the first reflective ball 112, the second reflective ball 114, and the third reflective ball 116, in the images captured by the first tracking camera 126 and the second tracking camera 128. In one embodiment, the positions of the tracking indicia can be provided from the position tracking system 130 to the computer 120 for the determination of the position and orientation of the probe 106 in the position tracking coordinate space 132.

Using the registration data, the real time image of the anatomical structure captured with the video camera 108 can also be overlaid with information generated based on the scan data 118, such as positions identified based on the scan data, diagnosis information, planned surgical path, an isolated anatomical structure (e.g., a tumor, a blood vessel, etc.)

In one embodiment, the accuracy of the image guided surgery system as illustrated in FIG. 1 is evaluated and visualized. Further details for accuracy evaluation can be found in U.S. Patent Application Publication No. 2005/0215879, filed Mar. 14, 2005 and entitled “Accuracy Evaluation of Video-Based Augmented Reality Enhanced Surgical Navigation Systems”, the disclosure of which is hereby incorporated by reference in its entirety.

For purposes of illustration, the anatomical object illustrated herein is a skull that is the subject of a craniotomy. However, one of ordinary skill in the art will appreciate that the system and method provided for herein can be utilized for any anatomical structure on a patient. Further, the system and method provided for herein are not limited to surgical procedures for humans and can be applicable to surgical procedures for animals, manufacturing processes that can benefit from enhanced visualization, etc.

In one embodiment, an accuracy evaluation module enables measurement of target registration error during an Image Guided application, which may use a Triplanar view and/or an augmented reality view to guide the navigation operations. In one embodiment, an accuracy evaluation module enables the visualization of target registration error.

In one embodiment, an accuracy evaluation module identifies feature points on a patient and the corresponding feature points of the patient in scan data, e.g., MRI, CT, or 3DUS. Based on the registration data that correlates the patient 102 and the scanned image of the patient 102, the positions of the feature points as identified on the patient 102 and the corresponding positions of the feature points as identified in the scan data 118 can be displayed in an augmented reality view for visualization of the registration error at the feature points. In one embodiment, the augmented reality view includes a real time video image obtained from the camera 108 mounted on the probe 106.

In one embodiment, the positions of the feature points of interest in the scan data 118 can be identified by selecting the corresponding points in a display of the scan data via a cursor control device during surgical planning. Alternatively, the feature points can be marked (e.g., using fiducials) such that the positions of the feature points in the scan data 118 can be determined automatically through identifying the images of the markers. Alternatively, a semi-automatic process may be used, in which a user may use a cursor control device to identify a region near the feature point, and a computer is utilized to process the image near the region to recognize the feature point through image processing and determine the position of the feature point in the scan data.

In one embodiment, the positions of the feature points of interest on the patient 102 in the operating room are identified utilizing the tracked probe 106. Alternatively, the feature points on the patient can be marked (e.g., using fiducials) such that the position of the feature points can also be tracked by the position tracking system 130. For example, a fiducial may be designed to have an automatically identifiable image in the scan data and in the tracking cameras 126 and 128 of the tracking system 130. Alternatively, other types of tracking systems can also be utilized. For example, a position tracking system may determine a position based on the delay in the propagation of a signal, such as a radio signal, an ultrasound signal, or a laser beam.

In one embodiment, the feature points are marked with ink and/or a fiducial device such that the precise locations of the feature points can also be identified in the real time video images obtained from the video camera 108 mounted on the probe 106.

In one embodiment, a first marker representing the position of the feature point as determined in the scan data 118 and a second marker representing the position of the feature point as determined via the position tracking system 130 are displayed together in an augmented reality view according to the registration data. In one embodiment, the augmented reality view includes the real time video image obtained from the video camera 108 mounted on the probe 106; and the augmented reality view is from the viewpoint of the video camera 108.

In one embodiment, the first and second markers are displayed on the display device 122. If the first marker and the second marker coincide with each other, there is no registration error at that point. The separation between the first and second markers indicate the registration error at that point, which in one embodiment can be viewed from different angles in the 3D space by changing the position and orientation of the probe 106. In one embodiment, indicators of registration errors are computed based on the positions of the first and second markers as displayed. For example, the distance in 3D space between the first and second markers can be computed to indicate a registration error. The distance may be measured according to a scale in the real space of the patient 102, or may be measured according to pixels in a triplanar view. Further, in one embodiment, the distance in the 3D space is projected to the plane of the real time video image to indicate an overlay error, which may be measured according to a scale in the real space of the patient 102, or according to the pixels in the real time video image.

In one embodiment, snapshots of the augmented reality view showing the separation of the first and second markers and the corresponding real time video image can be recorded (e.g., for documentation purpose). Further, separations at multiple feature points can be displayed simultaneously in a similar way in the same augmented reality view to show the distribution of registration error. In one embodiment, the registration error is shown via the separation of markers. Alternatively or in combination, a vector representation can also be used to show the separations at the feature points. Alternatively or in combination, the error indicators are displayed as text labels near the corresponding feature points.

In one embodiment, the feature points are located on a surface of the patient 102. A surface model of the patient 102 is generated from the scan data 118. During the accuracy evaluation process, the distance between the tip of the probe 106 and the closest point on the surface model of the patient 102 is computed based on the tracked position of the tip of the probe 106, the surface model generated from the scan data 118, and the registration data. When the registration is perfect, the computed distance is zero when the tip of the probe 106 touches the surface of the patient. A non-zero value of this distance when the tip of the probe 106 touches the surface of the patient is an indicator of registration error. In one embodiment, such a distance is computed, displayed with the augmented reality view, and updated as the tip of the probe 106 moves relative to the patient. When the tip of the probe 106 touches the feature point on the surface of the patient, the distance between the tip of the probe 106 and the closest point of the surface model is proportional to the projection of the registration error in the direction of the normal of the surface.

In one embodiment, a feature point for accuracy evaluation is marked with a fiducial, e.g., a donut shaped fiducial positioned on the scalp near the center of the planned opening. Alternatively or in combination, a feature point for accuracy evaluation can be an anatomical landmark, e.g., the nose tip, nasal base, and/or tragus on one side, or other points of interest.

The scan data 118 in FIG. 1 can be utilized to display a triplanar view, in which cross sections of a volume at three orthogonal planes are displayed in three windows. Each of the windows provides a different orthogonal cut through the scan data. Only one point in the space is shown in all of the three windows. The Triplanar views can be generated according to the position of one of the first and second markers. In general, the triplanar view cannot show both the first and second markers in the selected cross sections. At least one of the first and second markers is absent from at least one of three windows of the triplanar view.

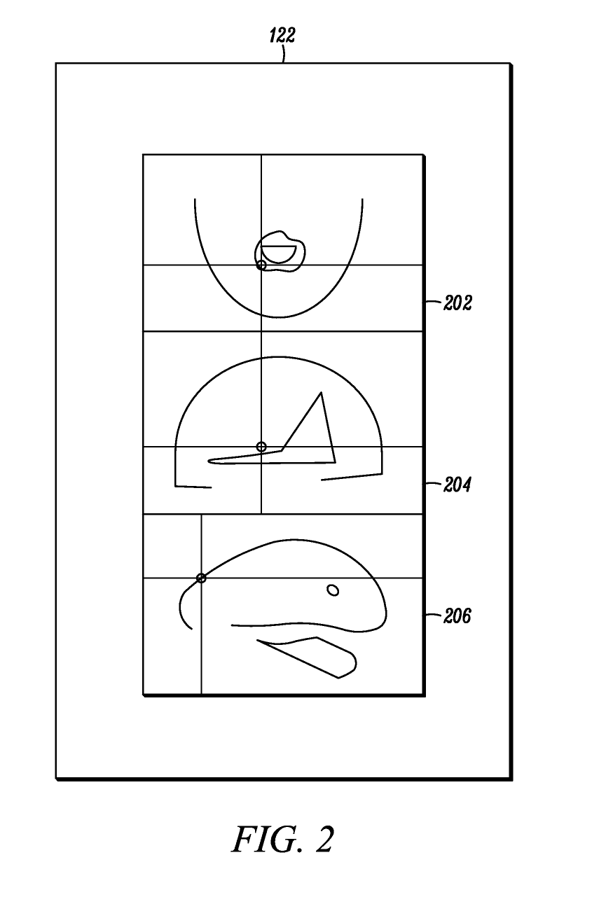

FIG. 2 illustrates a display device 122 showing a Triplanar view. As an example, each of the Triplanar windows displays an orthogonal cut of a scan data of a skull. For instance, a first Triplanar window 202 displays a top orthogonal view of the skull. Further, a second Triplanar window 204 displays a rear orthogonal view of the skull. Finally, a third Triplanar window 206 displays a side orthogonal view of the skull.

In FIG. 2, a cross-hair is illustrated in each of the Triplanar windows to indicate the position of the probe 106, as seen in FIG. 1. Accordingly, the surgeon can visualize the position of the probe 106 in the scan data 118 of the anatomical structure of the patient 102. For example, the position of the probe 106 as tracked by the position tracking system 130 can be converted into the corresponding position in the scan data 118 using the registration data; and the position of the probe as mapped into the scan data can be used to select the three cut planes.

When the tip of the probe 106 is at the feature point for accuracy evaluation, the corresponding feature point in the scan data 118 is typically not on one or more of the cut planes. Since the cut planes as defined by the feature point in the scan data are different from the cut planes selected by the position of the probe 106, the system guides the navigation of the probe 106 based on the cut planes that are in the vicinity of the actual point, when there is a registration error.

In one embodiment, an accuracy indicator is calculated based on a test point and a virtual point. The test point is a feature as determined on the patient, e.g., a fiducial marker or an anatomical landmark. For example, the probe 106, as seen in FIG. 1, can be utilized to determine the position of the test point on the patient. For example, the surgeon can touch the fiducial markers and/or anatomical landmarks with the probe 106 to allow the position tracking system 130 to determine the position of the test points in the position tracking coordinate system 132. In addition, the scan data 118 containing the image of the anatomical structure has a virtual test point that corresponds to the test point. For instance, if the nose tip on the patient 102 is designated as a test point, then the nose tip appearing in the scan data 118 is a virtual test point. The virtual test point can be identified via the visualization of the scan data 118 prior to the registration and/or during the surgical planning. Alternatively, the position of the virtual test point in the scan data 118 can be identified during or after the operation. The registration data should ideally have produced a mapping such that the coordinates of the nose tip on the patient 102 as determined by the position tracking system 130 match up with the coordinates of the nose tip in the scan data 11 8 with a very small margin of error.

One accuracy indicator is based on the differences between the positions of the test point and the virtual test point in the Triplanar view. An accurate registration will yield a miniscule difference in position. However, a difference that is not insignificant shall provide the surgeon with an indication that the planner surgical procedure may not be safe. In one embodiment, the indicator for a test point can be calculated using the following expression: \sqrt{(Δx)²+(Δy)²+(Δz)²}, where the term Δx refers to the difference in the x-coordinates of the test point and the virtual test point in the coordinate space of the Triplanar view; the term Δy refers to the difference in the y-coordinates of the test point and the virtual test point in the coordinate space of the Triplanar view; and the term Δz refers to the difference in the z-coordinates of the test point and the virtual test point in the coordinate space of the Triplanar view. Alternatively, the indicator can be determined based on the differences in the coordinate space of the augmented reality view. Alternatively, the indicator can be determined based on the differences in the coordinate system of the position tracking system.

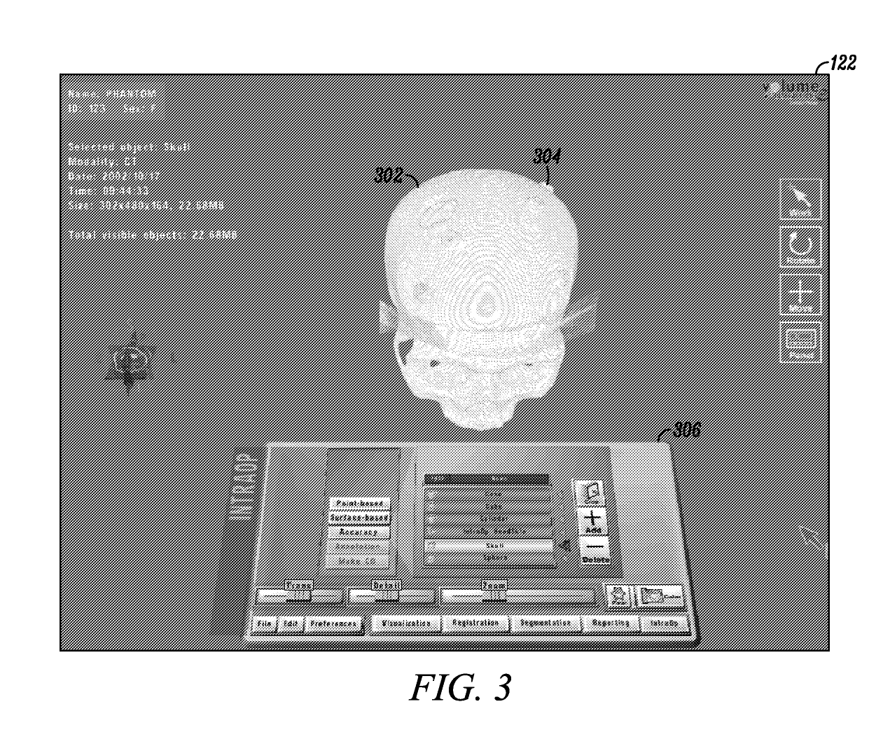

FIG. 3 illustrates the visualization of scan data of an anatomical structure of the patient 102. In particular, the head 302 of the patient 102 is displayed based on the scan data 118. A donut shaped fiducial marker 304 can be positioned on the anatomical structure to help identify the test point. For example, the donut shaped fiducial marker can be positioned close to the surgical opening. In one embodiment, a donut shaped fiducially marker is used in the accuracy evaluation; and a marking pen can be utilized after registration to place an ink dot at the center of the donut shaped fiducial and a circle around the donut shaped fiducial. In another embodiment, the ink dot can be made prior to the registration process and may or may not appear in the scanned image, but can be captured by the video camera 108 to show whether the tip of the probe 106 actually touched the intended location. In one embodiment, a plurality of landmarks, e.g., the base of the nose, the nose tip, and the tragus on one side of the head, can be identified on the head of the patient 102 without the utilization of a fiducial. Ink dots can be marked on the landmarks for identification purposes.

In one embodiment, the head 302 of the patient is displayed in a stereoscopic view based on the scan data 118. A tool panel 306 is displayed on a plane that coincides with a supporting surface to allow easy interaction with the elements of the tool panel 306.

As illustrated in FIG. 3, a plurality of possible landmarks can be selected as virtual test marks based on the visualization of the scan data. The user can identify the position of a landmark by moving a cursor to the landmark and activate a switch (e.g., a button) to click the corresponding point in the 3D view of the scan data. For instance, in one embodiment, a mouse or a position tracked stylus can be utilized to move a cursor (or a tool corresponding to the stylus) over the landmark of interest. The mouse (or the button on the position tracked stylus) can then be clicked by the user to indicate that the cursor's current position corresponds to the position of the landmark in the scan data. In one embodiment, the scan data 118 is displayed in a stereoscopic view. In one embodiment, once the position of the landmark is identified, a marker is displayed at the position of the landmark to indicate the identified position. In one embodiment, a cursor positioning device (e.g., a mouse, a track ball, a joystick, a position tracked stylus) can be also utilized to drag and drop a marker representing the identified position to a desired location (e.g., by dragging the marker to the position of the landmark as displayed in the view).

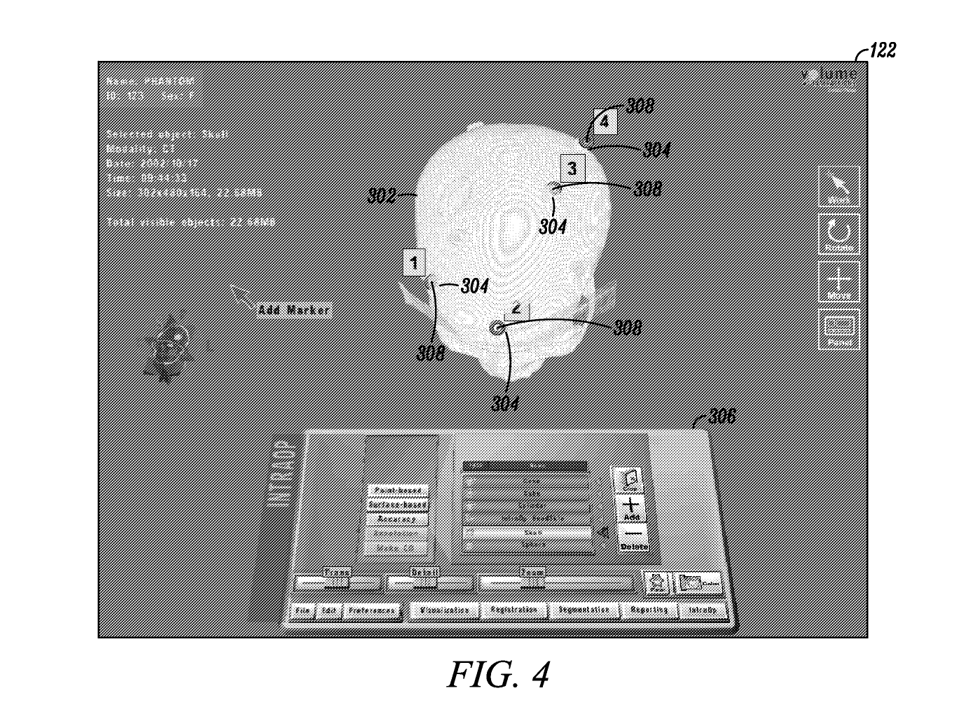

FIG. 4 illustrates the markers 308 that are displayed at the selected locations of the landmarks to indicate the positions of the landmarks in the scan data. In one embodiment, each marker 308 includes a point and a ring centered at that point, where the center point is at the identified position of the landmark. Alternatively, a variety of other shapes can be utilized to indicate the identified position of the landmark in the display of the scan data. In FIG. 4, a text label is displayed near each of the landmarks to help identify a particular landmark. For instance, as illustrated in FIG. 4, each of the intended landmarks is sequentially numbered for identification purpose.

In one embodiment, an Augmented Reality view shows the overlay of a real time image of the anatomical structure of the patient 102 with information generated based on the scan data 118. For instance, the real time image can be obtained from the camera 108 and provided to the computer 120. The computer 120 can generate the display that includes the overlay of the real time video image and the information generated based on the scan data 118, such as the position of a feature point, a segmented anatomical structure, a surgical plan, a surgical path planned based on the scan data 118, a model of a portion of a patient or tumor in the patient, diagnosis information, prior treatment information, etc.

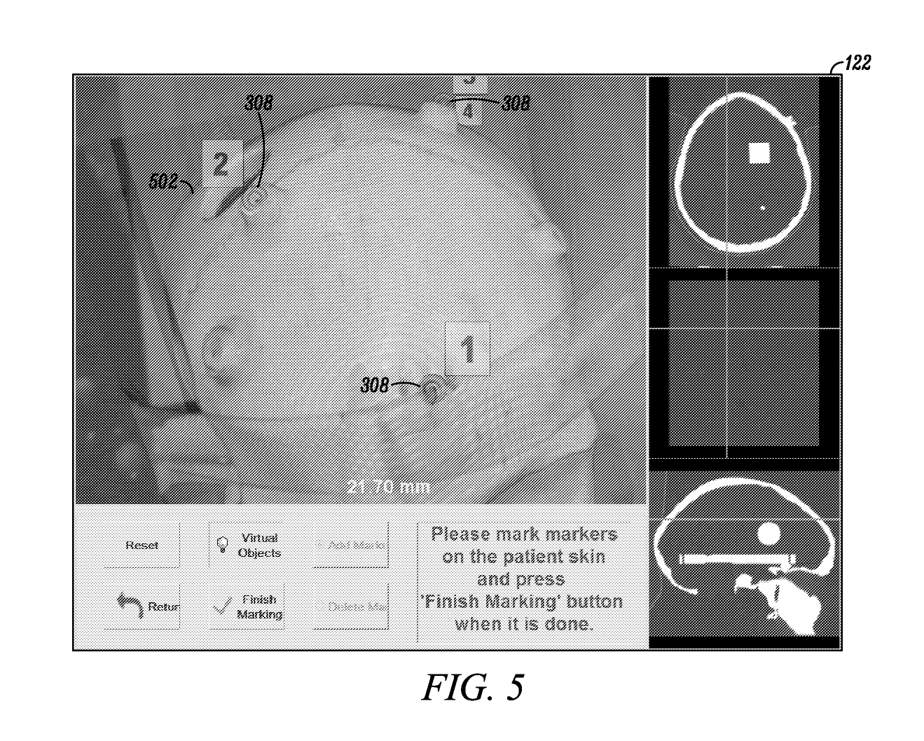

FIG. 5 illustrates a display of an Augmented Reality view for accuracy evaluation. As an example, in the Augmented Reality view, a real time image of the skull 502 is augmented with information based on the scan data 118. For example, based on the registration data, the positions of the landmarks as determined in the scan data 118 are displayed as markers 308 in the augmented reality view. In the Augmented Reality view 502, a tip portion of the probe 106 is also captured in the real time image in the lower center portion of the real time video image.

In one embodiment, based on a computerized model of the probe 106, a computer rendered image of the probe is mixed with the real time image of the tip portion of the probe 106. Any mismatch between the computerized model of the probe 106 and the real time video image of the tip portion of the probe indicates an error between the position of the tip of the probe as determined by the tracking system and the actual position of the tip of the probe.

In one embodiment, the user can utilize the tip of the probe 106 to touch the landmarks on the patient 102 to determine the positions of the landmarks according to the position tracking system. In one embodiment, a foot switch is kicked as the tip of the probe 106 touches the landmark on the patient 102 to indicate that the tip of the probe 106 is at the landmark. Thus, the system takes the position of the tip of the probe 106 as the position of one of the landmarks when the foot switch is kicked.

Since the positions of the landmarks are identified through position tracking system, these positions may not match perfectly with the positions of the corresponding landmarks that are identified through the visualization of the scan data. In one embodiment, the computer 120 displays another set of markers in the Augmented Reality view to represent the positions of the landmarks that are identified through position tracking system, in addition to the markers 308 that represent the positions of the landmarks that are identified in the scan data. The two sets of markers may overlap with each other to certain degree, depending on the registration error. If the registration error were zero, the two sets of markers would overlap with each other perfectly. Noticeable separation of the two sets of markers represents a noticeable registration error.

In one embodiment, the real time video image of the fiducials, landmarks and head 502 of the patient 102 can be seen in the Augmented Reality window 502. Since the two sets of positions of the landmarks are represented as two sets of markers, the spatial relation between the two sets of markers can be viewed and examined from various viewpoints to inspect the registration errors. For example, the user may change the position and orientation of the probe relative to the head of the patient to obtain a real time video image from a different view point; and the two sets of the markers are displayed according to the new view point of the probe.

In FIG. 5, the Augmented Reality view is displayed on the left hand side; and the triplanar view is displayed on the right hand side. In another embodiment, the Augmented Reality view can be displayed without the Triplanar view, and vice versa.

In one embodiment, the distance between the tip of the probe 106 and the nearest point of a surface of the objected as captured in the 3-D image is displayed in real time. When the tip touches the surface of the anatomical object, the displayed distance represents the registration error projected in a direction perpendicular to the surface. When the registration data is accurate or when the registration error is such that the point slides on the surface but does not project out of the surface, the distance is zero or approximately zero. In one embodiment, when the foot switch is kicked to indicate that the probe tip is at the position of the landmark, the system also records the distance between the tip of the probe 106 and the nearest point of a surface of the objected as captured in the 3-D image is displayed in real time. Alternatively, the system can compute the distance between the position of landmark as determined by the probe tip via the position tracking system and the nearest point of a surface of the objected as captured in the 3-D image based on the registration data, at any time after the position of landmark/probe tip is recorded.

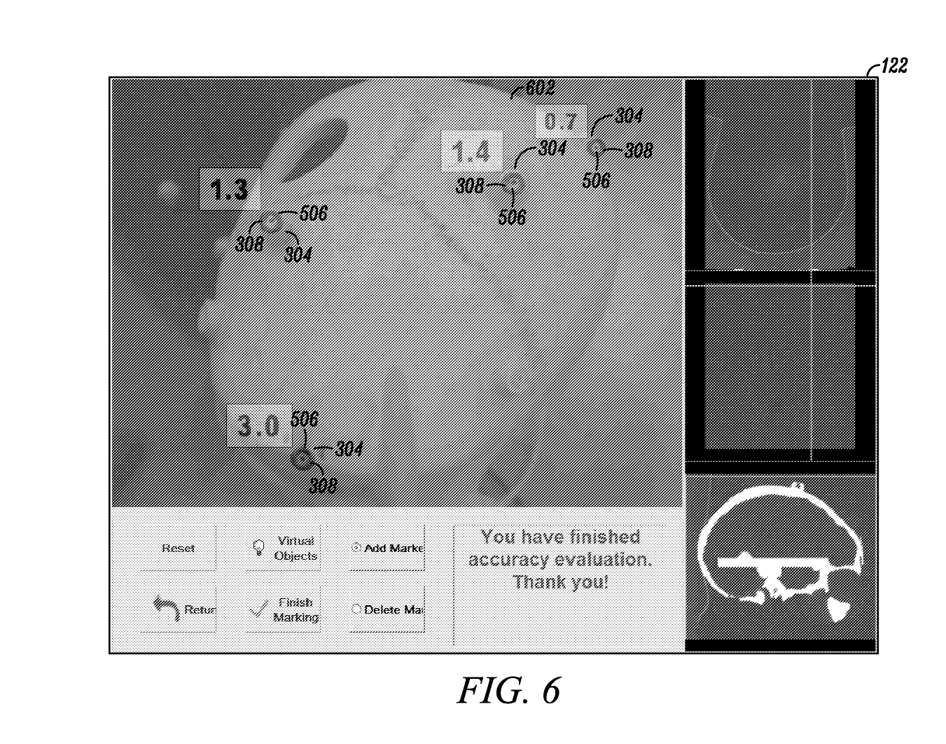

FIG. 6 illustrates the display device 122 showing a plurality of pairs of markers. In other words, for each intended landmark 304, a pair of markers is displayed, one marker 308 representing the position of the landmark as identified via the visualization of the scan data and another marker 506 representing the position of the landmark as identified via the position tracking system. In FIG. 6, the green markers represent the position of the landmark as identified via the position tracking system; and the grey portions of the markers represent the overlapping between the green markers and the markers that represent the position of the landmark as identified via the visualization of the scan data. The separation between the pair of markers 308 and 506 at each landmark 304 can be calculated for accuracy evaluation.

A variety of visualization features can be provided to show the accuracy of registration for the set of landmarks. For example, in FIG. 6, text labels are displayed near the corresponding landmarks to show the calculated registration error at the corresponding landmarks. In one embodiment, the displayed error is a registration error, which represents the distance in a 3D space between a pair of markers. In another embodiment, the displayed error is an overlay error, which represents the projected distance in a plane that is parallel to the plane of the real time video image. In one embodiment, the closest distance from a marker to a surface (e.g., the outer surface of the head) can be computed and displayed; the marker represents the position of the landmark as determined on the patient; and the surface is modeled or extracted based on the scan data. In one embodiment, the difference between the closest distances from the pair of markers to the surface are computed and displayed. In one embodiment, units of measure such as pixels and millimeters can be utilized for the error indicators.

In one embodiment, an overlay error is computed in the image plane of the real time video image. The position of the landmark as determined via the visualization of the scan data and the position of the landmark as determined via the position tracking system can be mapped to the image plane of the real time video image (e.g., via the registration data). The real time video image is displayed as part of the Augmented Reality view. In the image plane, the overlay error can be calculated for the landmark using the following expression: \sqrt{(Δx)²+(Δy)²}, where Δx is the difference in the x-coordinates of the two positions projected in the image plane; and Δy is the difference in the y-coordinates of the two positions projected in the image plane. In one embodiment, the overlay error is measured in the unit of pixels in the image plane of the real time video image. Such an overlay error indicates how well the scan data is aligned with the patient from the point of view of the real time video image. Accordingly, the overlay error provides a measure of how accurate the Augmented Reality view is for guiding the navigation of the probe 106.

In one embodiment, one or more snapshots of the Augmented Reality view can be taken to document the separation of the markers that represent the different positions of the landmark as determined via different methods (e.g., via the visualization of the scan data and via the position tracking system). These snapshots can document the distribution of registration error in a graphical way.

In one embodiment, landmarks for the accuracy evaluation can also be marked on the skin of the patient (e.g., using ink dots). Since the ink dots that represent landmarks are also captured in the snapshots of the Augmented Reality view (via the real time video image), one can examine the difference between an ink dot as shown in the snapshot and the marker that represents the position of the landmark as determined via the position tracking system to determine a human error in identifying the landmark to the position tracking system. For example, when the probe tip does not touch the ink dot accurately, there is an offset between the marker corresponding to the position determined by the probe tip (via the position tracking system) and the ink dot shown in the captured snapshot.

In one embodiment, the overlay error measured in the image plane can be mapped into a corresponding plane in the object space (e.g., the real space where the patient is). In one embodiment, the overlay error in a plane passing through the landmark in the object space is computed using the following expression: \sqrt{(ΔxZ_{c}/fₓ)²+(Δy Z_{c}/f_{y})²}, where fₓ and f_{y} are the effective focal length of the video camera in the x and y directions, known from the camera calibration; Z_{c} is the distance from the viewpoint of the video camera to the object plane that is parallel to the image plane and that passes through the landmark; Δx is the difference in the x-coordinates of the two positions in the image plane; and Δy is the difference in the y-coordinates of the two positions in the image plane.

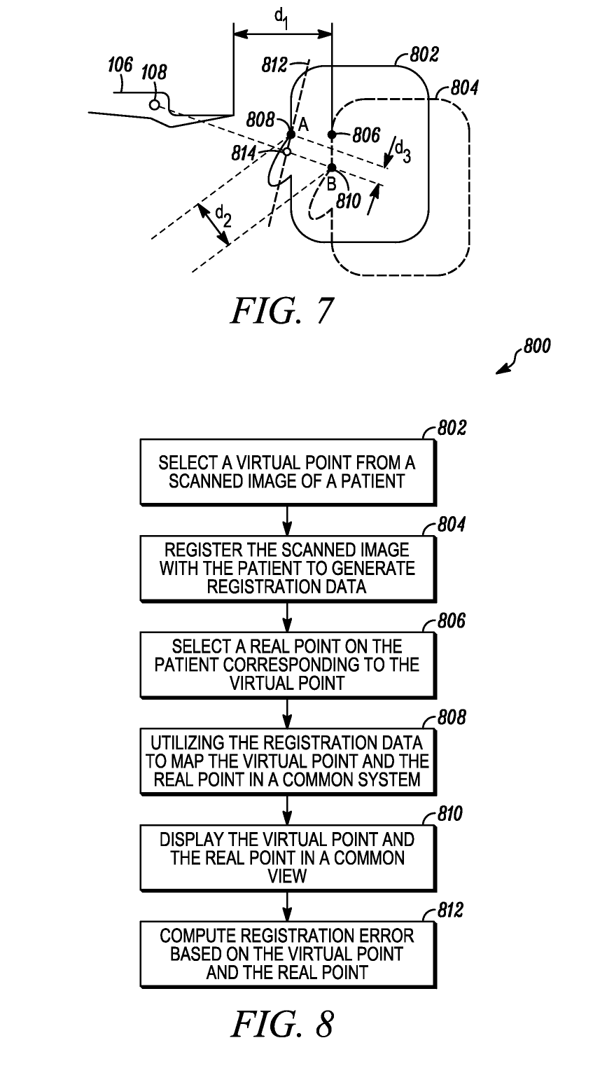

FIG. 7 illustrates the spatial relation of registration error. In FIG. 7, the image 804 of the skull 802 of the patient 102, as captured by the scan data 118, is registered with the skull 802 of the patient 1 02. Due to the registration error there is an offset between the actual skull 802 and the image 804 of the skull. A video image captured by the video camera 108 that is mounted on or in the probe 106 shows a surface portion of the skull 802 of the patient.

In FIG. 7, a landmark on the skull 802 is identified at position A 808 on the skull 802 using a position tracking system. For example, the position and orientation of the probe 106 is tracked using the position tracking system 130; and when the tip of the probe 106 touches the landmark at position A 808 on the skull 802, the position A 808 can be determined based on the tracked position of the tip of the probe 106.

The position B 810 of the landmark on the image 804 can be identified using a cursor to point to the landmark on the image 804 when the image 804 is displayed for visualization (e.g., in a stereoscopic view or a triplanar view). The distance d₂ between the position A 808 and position B 810 represents the registration error at the landmark.

In FIG. 7, the plane 812 passes through the landmark at the position A 808 on the skull 802 of the patient; and the plane 812 is parallel to the image plane of the video image that is captured by the video camera 108. The position B 810 of the landmark in the image 804 is projected onto the plane 812 at position 814 along the viewing direction of the camera 108. In the plane 812, the distance d₃ between the position A 808 and position 814 represents an overlay error.

In FIG. 7, the point 806 represents the current closest point to the tip of the probe 106, among points that are on the surface of the skull of the patient. The surface of the skull of the patient is determined based on the scan data 118. The distance d₁ between the tip of the probe 106 and the closest point 806 changes as the position of the probe 106 changes. When the tip of the probe 106 touches the landmark at position A 808 on the actual skull 802 of the patient, the distance represents the shortest distance from the landmark at position A 808 on the skull 802 to the surface of the skull in the registered image 804.

In one embodiment, after the positions A 808 and B 810 are determined, two markers are displayed at the two corresponding positions according to the registration data. The position and orientation of the probe 106 can be adjusted to obtain a real time video image of the skull 802; and the markers representing the positions A 808 and B 810 are overlaid on the real time video image to show the registration error in the context of the real time video image. Further, multiple pairs of markers can be overlaid simultaneously on the real time video image to show the distribution of registration error.

FIG. 8 illustrates a process 800 for performing accuracy evaluation for an Image Guided Surgery (IGS) system. At a process block 802, a virtual point is selected from a scanned image of the patient based on the scan data 118. The position of the virtual point in the scan data 118 is determined through the selection. At a process block 804, the scanned image is registered with the patient to generate registration data. The registration data spatially correlates the patient and the scan data. At a process block 806, a real point is selected on the patient 102. The real point corresponds to the virtual point. For example, it can be selected such that both the real point and the virtual point correspond to a landmark on a surface of the patient. At a process block 808, the virtual point and the real point are mapped into a common system utilizing the registration data determined from the process block 804. For example, a transformation is performed to transform the coordinates for the virtual point and the real point into a common coordinate system for overlay on a real time video image of the patient. At a process block 810, the real point and the virtual point are displayed in a common view (e.g., according to the common coordinate system). In one embodiment, computer generated markers are used to represent the real point and the virtual point in the common view. At a process block 812, registration error is computed based on the virtual point and the real point. For example, the registration error, overlay error, etc., can be displayed in text labels in the vicinity of the point in the Augmented Reality window, as seen in FIG. 6. The markers that represent the real point and the virtual point can also be shown in the Augmented Reality window. In one embodiment, a screen image showing the real time video image, the markers that represent the real point and the virtual point, and the text labels can be recorded (e.g., as a screen image). Alternatively, the position data and the real time video image can be separately stored such that the screen image can be re-generated from the stored data.

In one embodiment, an overlay error can be determined without determining the real point, since the real point is captured in the real time video image. From the snapshot that shows the real time video image and the marker of the virtual point, the distance between the real point as captured in the video image and the virtual point as represented by the marker can be measured. In one embodiment, the real point is ink marked (e.g., as an ink dot). Thus, in an Augmented Reality, the separation between the ink dot and the marker that represents the virtual point can be observer from different view points (e.g., by changing the position and orientation of the probe that contains the video camera).

In one embodiment, the position of the real point can also be identified via the real time video image, the view point of which is tracked by the position tracking system. For example, a cursor can be moved to the real point as captured in the video image to identify the position of the real point. For example, from two snapshots of the real point taken from two different viewing directions, the position of the real point can be computed from identifying the real point in the snapshots. Such a position of the real point can be compared to the position of the real point determined by the probe tip touching the real point (e.g., to determine the component of human error in the accuracy evaluation).

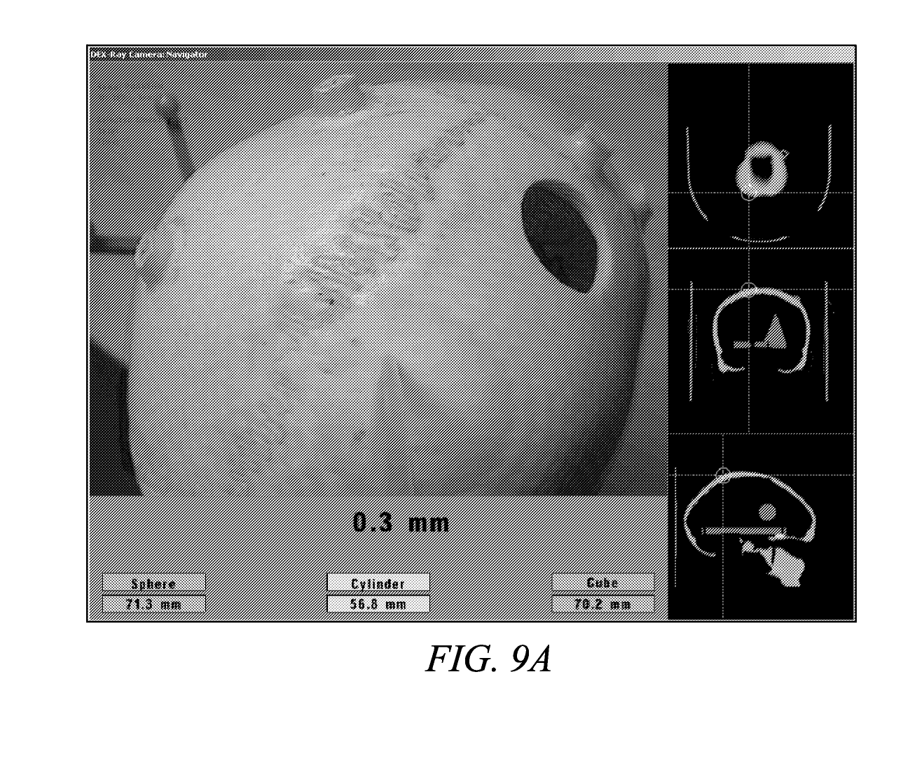

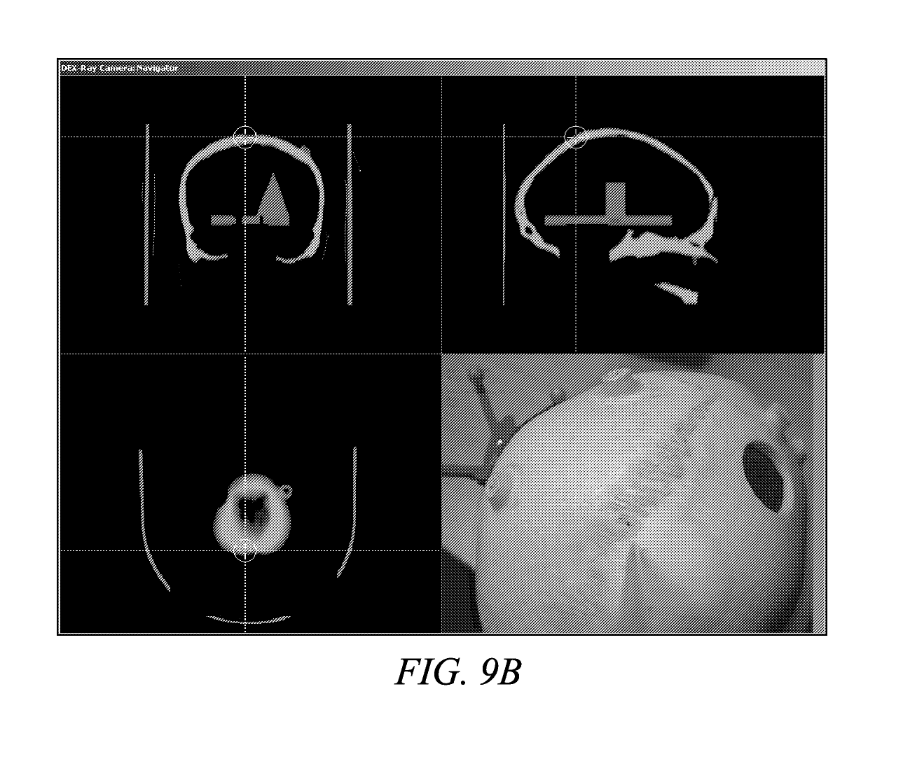

FIGS. 9A and 9B illustrate the display device showing both Augmented Reality and Triplanar views. For example, FIG. 9A has an Augmented Reality dominated view in which the Augmented Reality window on the left hand side of the screen takes up a larger portion of the display on the display device 122 than the three windows for the Triplanar view on the right hand side of the screen. On the other hand, FIG. 9B has a Triplanar dominated view in which the three windows for the Triplanar view take up a larger portion of the display on the display device 122 than the Augmented Reality window that is positioned at the lower right portion of the screen.

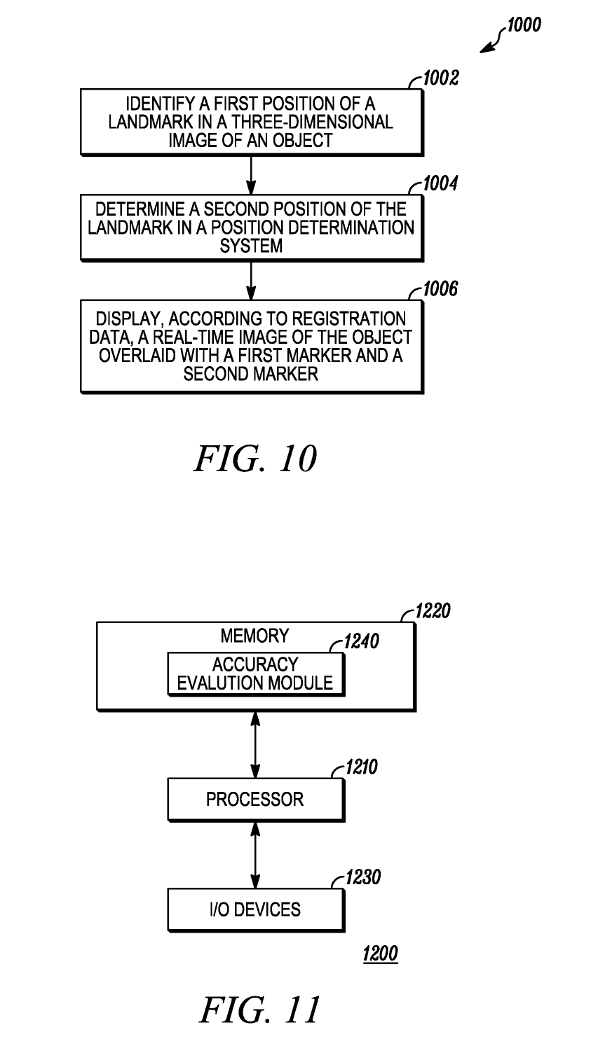

FIG. 10 illustrates a process 1100 for the visualization of registration accuracy. At a process block 1002, a first position of a landmark in a three-dimensional image of an object is identified. For example, in one embodiment, the first position can be measured according to the coordinate space of the display device 122 in which the computer generated image from the scan data 118 is displayed. The first position is represented relative to the scan data 118. At a process block 1004, a second position of the landmark in a position determination system is determined. For example, in one embodiment the position determination system determines the position of the landmark in the operating room. The second position is represented relative to the position determination system. At a process block 1006, a real time image of the object overlaid with a first marker and a second marker is displayed according to a set of registration data that correlates the three-dimensional image of the object and the object. The first marker represents the first position of the landmark identified in the three-dimensional image; and the second marker represents the second position of the landmark determined in the position determination system. Alternatively, the second marker is not displayed, since the landmark is captured in the real time video. In one embodiment, the real time video is processed to automatically determine the position of the landmark.

FIG. 11 illustrates a block diagram of a system 1200 that can be utilized to perform accuracy evaluation of an Image Guided Surgery (IGS) system. In one embodiment, the system 1200 is implemented using a general purpose computer or any other hardware equivalents. Thus, the system 1200 includes at least one processor (CPU/microprocessor) 1210, a memory 1220, which may include random access memory (RAM), one or more storage devices (e.g., a tape drive, a floppy drive, a hard disk drive or a compact disk drive), and/or read only memory (ROM), and various input/output devices 1230 (e.g., a receiver, a transmitter, a speaker, a display, an imaging sensor, such as those used in a digital still camera or digital video camera, a clock, an output port, a user input device, such as a keyboard, a keypad, a mouse, a position tracked stylus, a position tracked probe, a foot switch, 6-degree input device based on the position tracking of a handheld device, and the like, and/or a microphone for capturing speech commands, etc.). In one embodiment, accuracy evaluation module 1240 is implemented as a set of instructions which when executed in the processor 1210 causes the system to perform one or more methods described in the disclosure.

The accuracy evaluation module can also be implemented as one or more physical devices that are coupled to the CPU 1210 through a communication channel. For example, the accuracy evaluation module can be implemented using application specific integrated circuits (ASIC). Alternatively, the accuracy evaluation module can be implemented as a combination of hardware and software, where the software is loaded into the processor 1210 from the memory 1220 or over a network connection.

In one embodiment, the accuracy evaluation module 1240 (including associated data structures) of the present disclosure can be stored on a computer readable medium, e.g., RAM memory, magnetic or optical drive or diskette and the like.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the following claims. The specification and drawings are, accordingly, to be regarded in an illustrative sense rather than a restrictive sense.

1. A method, comprising:
identifying a position of a landmark in a three-dimensional image of an object; and
overlaying a first marker on a reality view of the object according to registration data that correlates the three-dimensional image of the object with the object, the first marker to represent the position of the landmark as being identified in the three-dimensional image.

2. The method of claim 1, wherein the reality view of the object comprises a real time image of the object

3. The method of claim 2, further comprising:
determining a position of the landmark on the object via a position determination system; and
overlaying a second marker on the real time image of the object, the second marker to represent the position of the landmark as being determined via the position determination system.

4. The method of claim 3, wherein said determining the position of the landmark via the position determination system comprises:
determining a location of a probe utilizing the position determination system when the probe is in contact with the landmark on the object.

5. The method of claim 4, wherein the real time image is obtained from a camera mounted in the probe.

6. The method of claim 4, further comprising:
determining a distance between a tip of the probe and a point on a surface of the object that is nearest to the tip of the probe;
wherein the surface of the object is modeled based on the three-dimensional image.

7. The method of claim 4, further comprising:
determining a distance between the second marker and a point on a surface of the object that is nearest to the second marker;
wherein the surface of the object is modeled based on the three-dimensional image.

8. The method of claim 3, further comprising:
displaying a label to show a distance between the first marker and the second marker.

9. The method of claim 3, further comprising:
projecting the first marker and the second marker onto a plane parallel to the real time image of the object.

10. The method of claim 9, further comprising:
determining the distance on the plane between the projected first marker and the projected second marker.

11. The method of claim 3, further comprising:
storing information for a display of the real time image of the object overlaid with the first marker and the second marker in response to a user input

12. The method of claim 3, wherein the real time image of the object is obtained from a first viewpoint; and the method further comprises:
displaying a subsequent real time image of the object overlaid with the first marker and the second marker according to the registration data, wherein the subsequent real time image is obtained from a second viewpoint that is distinct from the first viewpoint

13. A method, comprising;
selecting a virtual point on a landmark in a computerized image of an anatomical object;
registering the computerized image with the anatomical object to generate registration data;
selecting a real point on the landmark located on the anatomical object;
mapping the virtual point and the real point into a common system according to the registration data; and
displaying a first marker for the virtual point and a second marker for the real point in the common system.

14. The method of claim 13, wherein said displaying comprises:
overlaying the first marker and the second marker onto a real time image of the anatomical object.

15. The method of claim 14, further comprising:
determining an indicator of error in the registration data based on positions of the first marker and the second marker.

16. The method of claim 15, wherein said displaying further comprises:
overlaying a text label to display the indicator.

17. The method of claim 15, wherein the indicator represents a distance between the first marker and the second marker in a three-dimensional space.

18. The method of claim 15, wherein the indicator represents a distance between the first marker and the second marker in the real time image.

19. A data processing system, comprising:
an interface module for receiving an identification of a position of a landmark in a three-dimensional image of an object; and
a display generator for overlaying a first marker on a reality view of the object according to registration data that correlates the three-dimensional image of the object with the object, the first marker to represent the position of the landmark as being identified in the three- dimensional image.
